(19) United States
(12) Patent Application Publication
(10) Pub. No.: US 2016/0062109 A1
(43) Pub. Date: Mar. 3, 2016

(54) OPTICAL SCANNING DEVICE

(71) Applicant: PANASONIC INTELLECTUAL PROPERTY MANAGEMENT CO., LTD., Osaka (JP)

(72) Inventors: Akihiro MORIKAWA, Osaka (JP); Toshiaki HORIE, Osaka (JP); Takehiro KOBAYASHI, Osaka (JP); Shinsuke NAKAZONO, Osaka (JP)

(21) Appl. No.: 14/781,028

(22) PCT Filed: Feb. 9, 2015
(86) PCT No.: PCT/JP2015/000571

§ 371 Date: Sep. 28, 2015

(30) Foreign Application Priority Data
Mar. 27, 2014 (JP) 2014-065181
Jul. 10, 2014 (JP) 2014-142323

(51) Int. Cl. G02B 26/12; G02B 26/10; G02B 26/08

(52) U.S. Cl. CPC G02B 26/124; G02B 26/0833; G02B 26/125; G02B 26/105

(57) ABSTRACT

An optical scanning device includes: a case including a window; and an optical reflective element mounted in the case. The optical reflective element includes: a movable portion including a reflective surface; a beam having one end connected to the movable portion; and a fixed portion connected to the other end of the beam and fixed to the case. The fixed portion is approximately parallel to the window. The reflective surface is non-parallel to the fixed portion.

### TECHNICAL FIELD

The present disclosure relates to an optical scanning device which causes an optical reflective element to reflect a light beam emitted from a light source to scan the reflected light beam across a predetermined region.

### BACKGROUND ART

Optical scanning devices generally include a polygon mirror or a galvano mirror. In recent years, optical scanning devices including a small optical reflective element manufactured using a micro electro mechanical system (MEMS) process have been researched. The reflection angle of the optical reflective element manufactured using the MEMS process is controlled by driving a piezoelectric driver or an electrostatic driver for rotating the reflective surface. The optical reflective element is shaped by, for example, dry etching. A film which serves as the driver is formed by sputtering. This significantly downsizes the optical reflective element. Hence, such an optical reflective element manufactured using the MEMS process is significantly effective for downsizing the optical scanning device and reducing power consumption of the optical scanning device.

The characteristics of the driver of the optical reflective element are likely to be degraded. The reflective surface of the optical reflective element is susceptible to dust and water. Accordingly, the optical reflective element is disposed in a case in order to reduce degradation of the driver and to protect the reflective surface from dust and water. The case includes a window, along the path of a light beam emitted from the light source, for the light beam to enter and exit the case.

Accordingly, part of the light beam emitted from the light source is reflected off the window. The light reflected from the window is unnecessary in the scanning area. Hence, such a configuration has been researched where the light reflected from the window travels apart from the scanning area. For example, in the optical scanning device, the reflective surface of the optical reflective element is disposed non-parallel to the window. This allows the light reflected from the window to travel apart from the scanning area.

For example, Patent Literature (PTL) 1 and PTL 2 disclose conventional techniques related to the present disclosure.

### CITATION LIST

### Patent Literature

PTL 1: Japanese Unexamined Patent Application Publication No. 2009-69457

PTL 2: Japanese Unexamined Patent Application Publication No. 2003-75618

### SUMMARY OF THE INVENTION

### Technical Problem

However, the configuration of the conventional optical scanning devices, where the reflective surface of the optical reflective element is disposed non-parallel to the window requires a complicated mounting process. This results in a decrease in productivity of the optical scanning device. Hence, there is a demand for an optical scanning device with high productivity.

### Solution to Problem

An optical scanning device according to the present disclosure includes a case including a window; and an optical reflective element disposed in the case. The optical reflective element includes: a movable portion including a reflective surface; a beam having one end connected to the movable portion; and a fixed portion connected to an other end of the beam and fixed to the case. The fixed portion is approximately parallel to the window, and the reflective surface is non-parallel to the fixed portion.

### Advantageous Effect of Invention

An optical scanning device, according to the present disclosure, which has a small size and allows a less amount of unnecessary light to enter the scanning area, has increased productivity.

### BRIEF DESCRIPTION OF DRAWINGS

FIG. 1 is a cross-sectional view of an optical scanning device according to one embodiment of the present disclosure.

FIG. 2 is a top view of an optical reflective element according to one embodiment of the present disclosure.

FIG. 3 schematically illustrates a method of manufacturing the optical reflective element according to one embodiment of the present disclosure.

FIG. 4 is a top view of an optical reflective element according to another embodiment of the present disclosure.

FIG. 5 is a cross-sectional view of the optical reflective element according to another embodiment of the present disclosure.

FIG. 6 is a cross-sectional view of an optical scanning device according to another embodiment of the present disclosure.

FIG. 7 is a cross-sectional view of an optical scanning device according to another embodiment of the present disclosure.

### DESCRIPTION OF EMBODIMENT

Prior to describing the present disclosure, a problem in a conventional optical scanning device will be described below.

In the conventional optical scanning device, the reflective surface of the optical reflective element is disposed non-parallel to the window. The reflective surface can be disposed non-parallel to the window by, for example, mounting the optical reflective element so as to be non-parallel to and inclined with respect to the window when mounting the optical reflective element in the case. However, such a method, in which the optical reflective element is mounted in the case so as to be inclined with respect to the window, requires a complicated mounting process. Another method is to dispose the window so as to be inclined with respect to the case and joint the window to the case. However, disposing the window so as to be inclined with respect to the case requires formation of a protrusion on the joint surface of the case, which also requires a complicated manufacturing process. Moreover, the protrusion disposed in the case results in an increase in size of the case itself.

### Embodiment

Hereinafter, an optical scanning device according to Embodiment of the present disclosure will be described with reference to the drawings. It should be noted that the following embodiment shows one specific example of the present disclosure. The numerical values, shapes, structural elements, the arrangement and connection of the structural elements etc., shown in the following embodiment are mere examples, and therefore do not limit the present disclosure. As such, among the structural elements in the following embodiment, structural elements not recited in any one of the independent claims which indicate the broadest concepts of the present disclosure are described as arbitrary structural elements.

Note that the respective figures are schematic diagrams and are not necessarily precise illustrations. Additionally, substantially the same structural elements share like reference numbers in the drawings, and duplicated descriptions are omitted or simplified.

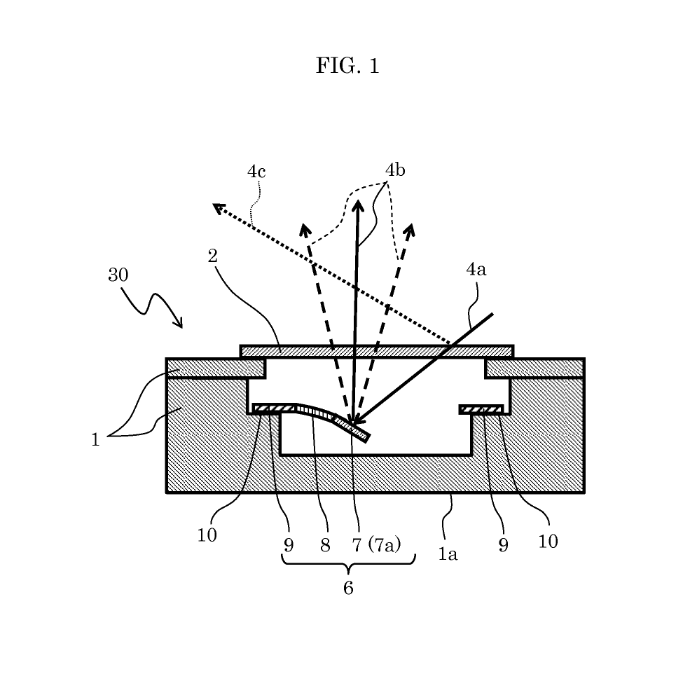

FIG. 1 is a cross-sectional view of optical scanning device 30.

Optical scanning device 30 includes: case 1; and optical reflective element 6 disposed in case 1. Disposing optical reflective element 6 in case 1 reduces degradation of optical reflective element 6. Additionally, disposing optical reflective element 6 in case 1 protects optical reflective element 6 from dust and water. Case 1 includes window 2 along the path of incident light 4a. Optical reflective element 6 includes reflective surface 7a which is rotatable. Optical scanning device 30 controls the reflection angle of incident light 4a entering optical scanning device 30, by controlling the rotation of reflective surface 7a. Accordingly, optical scanning device 30 scans reflected light 4b across a predetermined area.

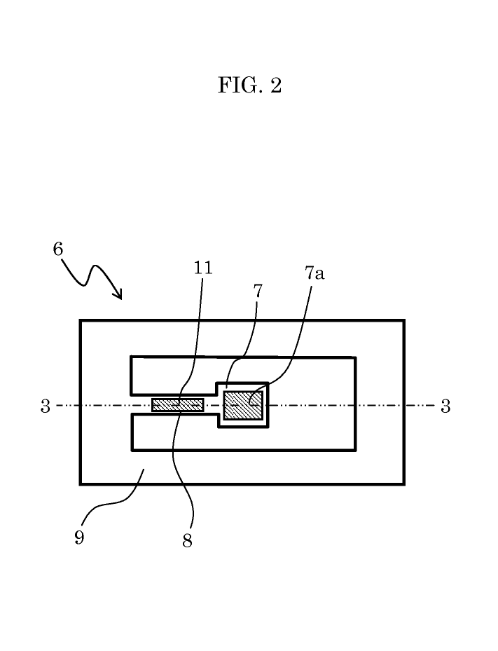

FIG. 2 is a top view of optical reflective element 6. As FIG. 2 illustrates, optical reflective element 6 includes fixed portion 9, movable portion 7, and beam 8. Fixed portion 9 has a frame like shape. Fixed portion 9 of optical reflective element 6 is connected to case 1. Plate-like movable portion 7 on which reflective surface 7a is disposed is disposed in the central portion of fixed portion 9. Beam 8 is disposed between movable portion 7 and fixed portion 9, and connects movable portion 7 to fixed portion 9. Beam 8 has a straight plate-like shape. Beam 8 has a surface on which driver 11 is disposed. Driver 11 causes vertical flexural vibration of beam 8.

Although not illustrated in the drawings, driver 11 has a multi-layer structure including an upper electrode, a piezoelectric layer, and a lower electrode. The piezoelectric layer is disposed between the upper electrode and the lower electrode. Driver 11 causes vertical flexural vibration of beam 8 upon application of a control voltage between the upper electrode and the lower electrode.

Driver 11 may be driven not only by the piezoelectric driving method but also by other conventional driving methods such as an electrostatic driving method using static electricity between opposing electrodes.

Optical scanning device 30 controls the angle of reflective surface 7a of movable portion 7 by causing driver 11 to vibrate beam 8. Accordingly, optical scanning device 30 changes the reflection angle of incident light 4a. Hence, optical scanning device 30 is capable of scanning reflected light 4b across a predetermined area.

The main surface of movable portion 7 having reflective surface 7a is disposed non-parallel to the main surface of window 2. With this, reflected light 4c resulting from incident light 4a being reflected off window 2 falls out of the scanning area. In optical scanning device 30, the inner wall portion of case 1 includes mounting surface 10. Fixed portion 9 of optical reflective element 6 is connected to mounting surface 10. Fixed portion 9 and the main surface of window 2 disposed on the top surface of case 1 are disposed approximately parallel to bottom surface 1a of case 1. On the other hand, the main surface of movable portion 7 having reflective surface 7a is disposed non-parallel to the main surface of window 2. In other words, in optical reflective element 6, fixed portion 9 is non-parallel to reflective surface 7a.

Such a configuration allows the shape of case 1 to be a simple one such as a cuboid, which prevents the size of optical scanning device 30 from increasing. When optical reflective element 6 and window 2 are connected to case 1, fixed portion 9 of optical reflective element 6 and window 2 which serve as connection portions to case 1 are approximately parallel to each other. Hence, the work reference surface in each connecting process is the plane approximately parallel to bottom surface 1a of case 1. This increases the productivity of optical scanning device 30 having a configuration where window 2 is non-parallel to reflective surface 7a. Fixed portion 9, window 2 and bottom surface 1a of case 1 may be parallel to each other. The configuration where fixed portion 9, window 2, and bottom surface 1a of case 1 are parallel to each other further increases productivity of optical scanning device 30.

In other words, optical scanning device 30 includes: case 1 including window 2; and optical reflective element 6 mounted in case 1. Optical reflective element 6 includes: movable portion 7 including reflective surface 7a; beam 8 having one end connected to movable portion 7; and fixed portion 9 connected to the other end of beam 8 and fixed to case 1. Fixed portion 9 is approximately parallel to window 2. Reflective surface 7a is non-parallel to fixed portion 9.

Such a configuration eliminates the need for a complicated mounting process, leading to optical scanning device 30 with high productivity. Additionally, high productivity can be provided in small optical scanning device 30 which allows less unnecessary light to enter the scanning area.

In order to dispose fixed portion 9 non-parallel to movable portion 7, movable portion 7 is formed so as to be inclined with respect to fixed portion 9 in advance. For example, beam 8 of optical reflective element 6 can be flexed in the vibrating direction of beam 8 in an initial state where no driving force is applied by driver 11, by remaining the internal stress in beam 8. Consequently, flexure of beam 8 due to the internal stress remained in beam 8 allows movable portion 7 to be inclined with respect to fixed portion 9.

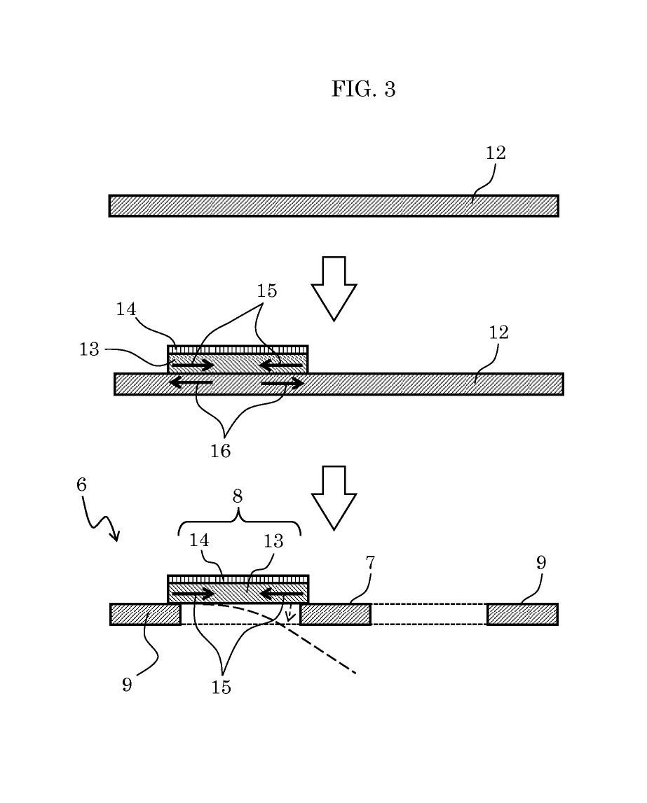

A specific example of how to remain the internal stress in beam 8 will be described referring to FIG. 3.

FIG. 3 illustrates a cross section taken along line 3-3 of optical reflective element 6 in FIG. 2.

Substrate 12 is a substrate which forms movable portion 7 and fixed portion 9 in optical reflective element 6. Fixed portion 9 is the outer periphery portion of substrate 12. Movable portion 7 is the inner portion of substrate 12. Substrate 12 comprises, for example, Si. An epoxy resin is applied to a portion of substrate 12 corresponding to beam 8 by spin coating to form first layer 13. First layer 13 comprises a material having a linear thermal expansion coefficient different from that of the material of substrate 12. Next, the surface of first layer 13 is plated by a metal such as Ni to form second layer 14. Second layer 14 is disposed to support first layer 13. Subsequently, an unnecessary portion of substrate 12 is removed by dry etching. The unnecessary portion is an area between fixed portion 9 and movable portion 7, and includes a portion which contacts first layer 13 forming beam 8. Such a manufacturing process allows movable portion 7 to be inclined with respect to fixed portion 9 easily without requiring a special manufacturing process.

The following describes a case where the linear thermal expansion coefficient of first layer 13 is greater than that of substrate 12.

In the forming process of first layer 13 by spin coating, optical reflective element 6 is heated. At this time, since first layer 13 has a linear thermal expansion coefficient greater than that of substrate 12, first layer 13 expands in a greater level than substrate 12. After formation of first layer 13, the temperature of first layer 13 is reduced while being fixed on substrate 12. Accordingly, internal stress 15 due to thermal shrinkage acts on first layer 13. Additionally, since first layer 13 is fixed on substrate 12, tensile stress 16 acting in a direction opposite to internal stress 15 acts on substrate 12. Subsequently, the unnecessary portion of substrate 12 below first layer 13 is removed while the internal stress is being applied to first layer 13. Removal of the unnecessary portion of substrate 12 releases the fixation of first layer 13, which had been in contact with the unnecessary portion, on substrate 12. In other words, relative to internal stress 15 remaining in first layer 13, no tensile stress 16 of substrate 12 which tries to fix first layer 13 acts. Accordingly, internal stress 15 of first layer 13 acts as a bending moment on second layer 14 which supports first layer 13. Hence, as illustrated in a dashed line, first layer 13 can be flexed in a direction opposite to second layer 14. As a result, movable portion 7 connected to beam 8 can be inclined with respect to fixed portion 9. Adjustment of the size and position of the unnecessary portion to be removed allows the inclining of movable portion 7 with respect to fixed portion 9 to be adjusted.

As described above, beam 8 includes a multi-layer structure including first layer 13 and second layer 14. Second layer 14 supports first layer 13. The linear thermal expansion coefficient of first layer 13 is different from that of fixed portion 9. Accordingly, with beam 8, movable portion 7 can be easily inclined with respect to fixed portion 9.

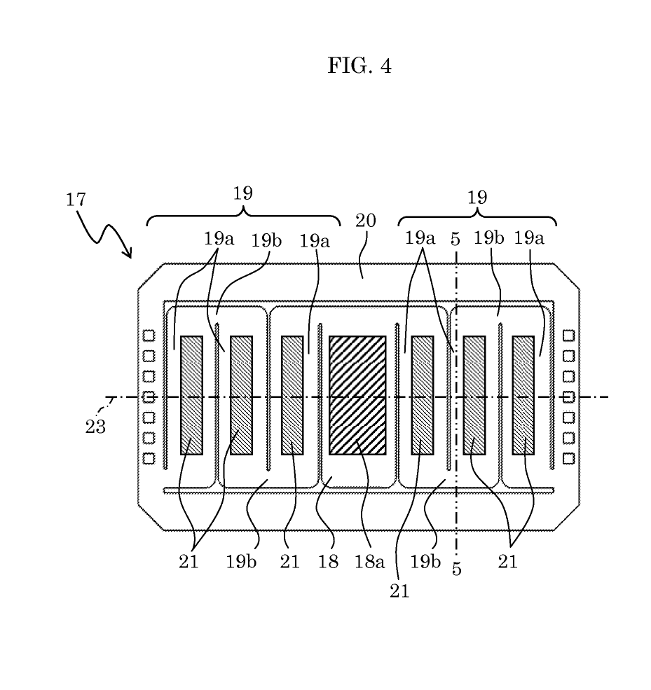

Next, a variation of the optical reflective element will be described referring to FIG. 4.

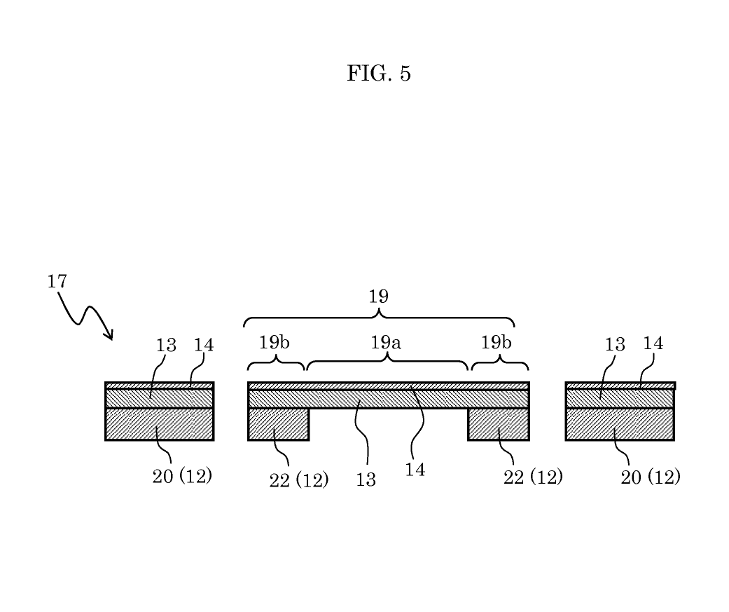

FIG. 4 is a top view of optical reflective element 17. FIG. 5 illustrates a cross section taken along line 5-5 of optical reflective element 17 in FIG. 4. In optical reflective element 17, movable portion 18 is connected to fixed portion 20 via a pair of beams 19. The shape of each beam 19 is a continuous meandering shape including a combination of straight portions 19a each having a straight plate-like shape and folded portions 19b each reversely connecting adjacent straight portions 19a. Movable portion 18 has a surface on which reflective surface 18a is disposed. The meandering shape of beam 19 of optical reflective element 17 allows the displacement angle of movable portion 18 to be greater than that of movable portion 7 of optical reflective element 6 including straight plate-like shaped beam 8 illustrated in FIG. 2.

Beam 19 includes a surface on which drivers 21 are disposed. Beam 19 having a meandering structure is vibrated by drivers 21, causing straight portions 19a to be flexed. Beam 19 can accumulate flexure of a plurality of straight portions 19a, and thus, the displacement angle can be increased according to the number of straight portions 19a. By remaining internal stress 15 in each beam 19, movable portion 18 can be inclined with respect to fixed portion 20 in the initial state where no driving force is being applied by drivers 21.

In FIG. 4, each of a pair of beams 19 includes three straight portions 19a. In the continuous meandering structure, adjacent straight portions 19a extend in opposite directions. Accordingly, the meandering structure may have an odd number of straight portions 19a. An odd number of straight portions 19a allows the number of straight portions 19a having a flexure in a forward direction to be different from the number of straight portions 19a having a flexure in the opposite direction. Hence, beam 19 can easily secure flexure in the initial state.

As described above, beam 19 has a meandering shape including a plurality of straight portions 19a extending linearly and folded portions 19b each connecting adjacent straight portions 19a. The number of straight portions 19a is odd. Accordingly, with beam 19, movable portion 18 can be easily inclined with respect to fixed portion 20.

Optical reflective element 17 can be formed in a similar manner to the formation process described referring to FIG. 3. Entire straight portions 19a of beam 19 may have a multi-layer structure including first layer 13 and second layer 14. Here, as illustrated in FIG. 5, each folded portion 19b may include weight body 22. Addition of weight body 22 to folded portion 19b allows the flexure of beam 19 in the initial state to be greater.

Weight body 22 may be part of substrate 12. Substrate 12 is a substrate of optical reflective element 17. Fixed portion 20 and movable portion 18 each include substrate 12. In the manufacturing process of optical reflective element 17, unnecessary portion of substrate 12 is removed by etching in the above described manner. In the removal process, it may be that a portion of substrate 12 corresponding to straight portion 19a is removed and etching is performed so as to remain a portion of substrate 12 corresponding to folded portion 19b. This allows portion of substrate 12 to be disposed on folded portion 19b as weight body 22. Accordingly, weight body 22 can be easily formed on folded portion 19b of beam 19. In this manner, weight body 22 may comprise a material identical to the material of fixed portion 20. In optical reflective element 17, first layer 13 and second layer 14 are disposed on the surface of fixed portion 20 as well.

Optical reflective element 17 which includes beams 19 each having the meandering structure illustrated in FIG. 4 is a single-axis scanning optical reflective element. In optical reflective element 17, movable portion 18 rotates about rotation axis 23. Although not illustrated in the drawings, optical reflective element 17 may be a two-axis scanning optical reflective element by replacing movable portion 18 with a movable frame. In the two-axis scanning optical reflective element, the movable frame includes a pair of beams and a movable portion. The pair of beams in the movable frame includes a rotation axis different from rotation axis 23. Such a two-axis scanning optical reflective element has the advantageous effects similar to those of the one-axis scanning optical reflective element.

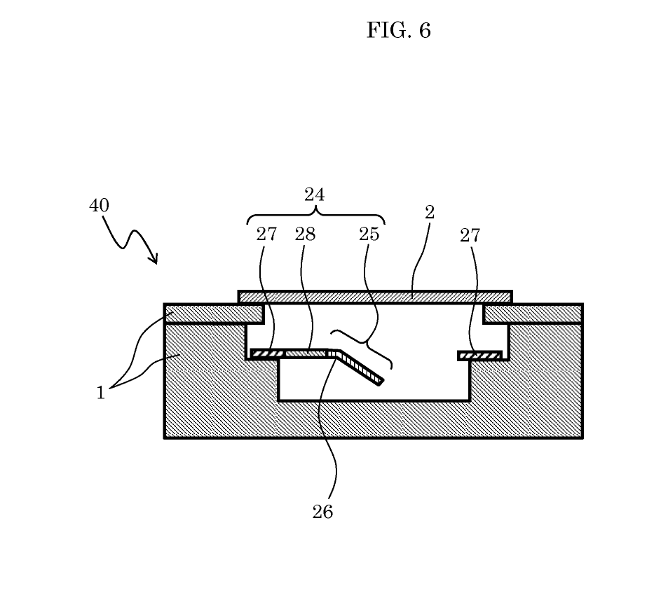

Next, a variation of the optical scanning device will be described referring to FIG. 6. FIG. 6 is a cross-sectional view of optical scanning device 40. Optical scanning device 40 is different from optical scanning device 30 illustrated in FIG. 1 in the shape of optical reflective element 24 disposed in case 1. Movable portion 25 of optical reflective element 24 includes bent portion 26. Bent portion 26 of movable portion 25 makes movable portion 25 inclined with respect to fixed portion 27. Bent portion 26 is, for example, formed by bending movable portion 25 over the plastic limit. The position of bent portion 26 is not limited to movable portion 25. For example, forming bent portion 26 in beam 28 also provides similar advantageous effects. As described above, in the optical scanning device, movable portion 25 or beam 28 may include a bent portion.

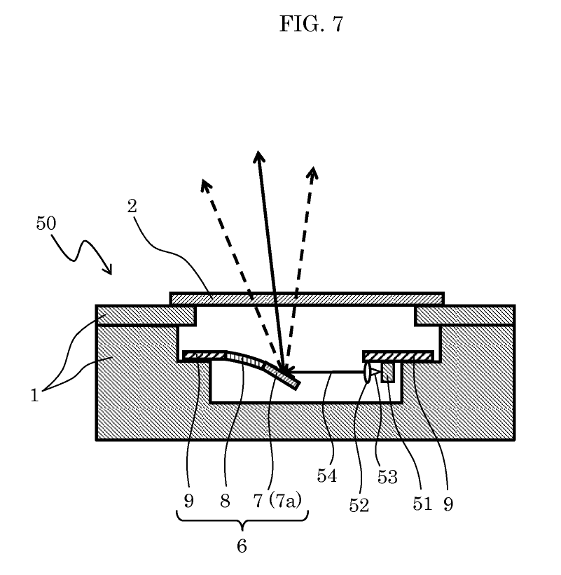

Moreover, optical scanning device 50 according to another variation will be described referring to FIG. 7. FIG. 7 is a cross-sectional view of optical scanning device 50. Optical scanning device 50 is different from optical scanning devices 30 and 40 in that a light source is disposed in case 1. In other words, optical scanning device 50 further includes a light source disposed in the case. The light source comprises, for example, semiconductor laser chip 51. Semiconductor laser chip 51 is mounted on the main surface of fixed portion 9 of optical reflective element 6. The portion of fixed portion 9 on which semiconductor laser chip 51 is mounted is positioned at the opposing corner of the portion to which movable portion 7 and beam 8 are connected. In such a manner, the light source comprises semiconductor laser chip 51 which is mounted on fixed portion 9. Semiconductor laser chip 51 disposed in case 1 allows the light beam emitted from the light source to reflect off window 2 into the interior of case 1. Accordingly, the light emitted from the light source and reflected off window 2 is unlikely to be emitted to the scanning area outside case 1. This allows optical scanning device 50 to reduce the amount of unnecessary light emitted to the scanning area, allowing projection of clear and highly precise images.

Moreover, when mounting semiconductor laser chip 51 on fixed portion 9 of optical reflective element 6, matching of optical axes of semiconductor laser chip 51 and movable portion 7 including reflective surface 7a can be performed significantly easier and more precisely than the case where the light source is disposed outside case 1. Light beam shaping component 52 may be disposed between semiconductor laser chip 51 and reflective surface 7a. Light beam shaping component 52 forms a portion of the light source mounted on fixed portion 9. Light beam shaping component 52 converts the shape of flux of light emitted from semiconductor laser chip 51 into a desired shape. For example, light beam shaping component 52 converts elliptical divergent light flux 53 emitted from semiconductor laser chip 51 into circular parallel light flux 54. Light beam shaping component 52 may comprise a collimator lens, a prism, a cylindrical lens, a troidal lens or a combination thereof. As described above, optical scanning device 50 further includes light beam shaping component 52 which converts the shape of light flux. Light beam shaping component 52 is disposed on fixed portion 9 between semiconductor laser chip 51 and reflective surface 7a. Mounting light beam shaping component 52 onto fixed portion 9 of optical reflective element 6 allows the optical axes of semiconductor laser chip 51 and light beam shaping component 52 and reflective surface 7a to be matched more precisely.

In the present variation, semiconductor laser chip 51 and light beam shaping component 52 are mounted on the main surface of fixed portion 9 of optical reflective element 6. However, instead of optical reflective element 6, optical reflective element 17 illustrated in FIG. 4 or optical reflective element 24 illustrated in FIG. 6 may be used. In optical reflective element 17, semiconductor laser chip 51 and light beam shaping component 52 are mounted on the main surface of fixed portion 20. In optical reflective element 24, semiconductor laser chip 51 and light beam shaping component 52 are mounted on the main surface of fixed portion 27. Such configurations also provide similar advantageous effects.

The optical scanning device according to one or more aspects has been described above based on the embodiment above. However, the present disclosure is not limited to the above embodiment. Those skilled in the art would readily appreciate that, without departing from the concept the present disclosure, various modifications may be made in the above-described embodiment and other embodiments may be obtained by arbitrarily combining structural elements in the above-described embodiment.

### INDUSTRIAL APPLICABILITY

The present disclosure is effective in an in-vehicle optical scanning device.

### REFERENCE MARKS IN THE DRAWINGS

1 case
2 window
4a incident light
4b, 4c reflected light
6, 17, 24 optical reflective element
7, 18, 25 movable portion
7a, 18a reflective surface
8, 19, 28 beam
9, 20, 27 fixed portion
10 mounting surface
11, 21 driver
12 substrate
13 first layer
14 second layer
15 internal stress
16 tensile stress
19a straight portion
19b folded portion
22 weight body
23 rotation axis
26 bent portion
30, 40, 50 optical scanning device
51 semiconductor laser chip
52 light beam shaping component
53 divergent light flux
54 parallel light flux

1. An optical scanning device comprising:
a case including a window; and
an optical reflective element disposed in the case,
wherein the optical reflective element includes:
a movable portion including a reflective surface;
a beam having one end connected to the movable portion; and
a fixed portion connected to an other end of the beam and fixed to the case, and
wherein, in an initial state where no driving force is applied to the optical reflective element, the fixed portion is approximately parallel to the window, and the reflective surface is non-parallel to the fixed portion.

2. The optical scanning device according to claim 1,
wherein the beam is flexed in a vibrating direction of the beam in advance.

3. The optical scanning device according to claim 2,
wherein the beam has an internal stress.

4. The optical scanning device according to claim 3,
wherein the beam has a multi-layer structure including a first layer and a second layer,
the second layer supports the first layer, and
the first layer has a linear thermal expansion coefficient different from a linear thermal expansion coefficient of the fixed portion.

5. The optical scanning device according to claim 4,
wherein the beam has a meandering shape including a plurality of straight portions extending linearly and a folded portion connecting adjacent ones of the plurality of straight portions, and
the plurality of straight portions comprise an odd number of straight portions.

6. The optical scanning device according to claim 5,
wherein the folded portion includes a weight body.

7. The optical scanning device according to claim 6,
wherein the weight body comprises a material identical to a material of the fixed portion.

8. The optical scanning device according to claim 1,
wherein at least one of the movable portion or the beam includes a bent portion.

9. The optical scanning device according to claim 1, further comprising
a light source disposed in the case.

10. The optical scanning device according to claim 9,
wherein the light source is a semiconductor laser chip mounted on the fixed portion.

11. The optical scanning device according to claim 10, further comprising
a light beam shaping component which converts a shape of a beam flux,
wherein the light beam shaping component is disposed on the fixed portion between the semiconductor laser chip and the reflective surface.
